(19) United States
(12) Patent Application Publication
(10) Pub. No.: US 2017/0316506 A1
(43) Pub. Date: Nov. 2, 2017

(54) DETECTION OF AGGREGATION FAILURES FROM CORRELATION OF CHANGE POINT ACROSS INDEPENDENT FEEDS

(71) Applicant: Intuit Inc., Mountain View, CA (US)

(72) Inventors: Christopher Lesner, Palo Alto, CA (US); Alexander S. Ran, Palo Alto, CA (US)

(73) Assignee: Intuit Inc., Mountain View, CA (US)

(21) Appl. No.: 15/140,099

(22) Filed: Apr. 27, 2016

(51) Int. Cl. G06Q 40/06; G06Q 40/02; G06Q 20/10

(52) U.S. Cl. CPC G06Q 40/06; G06Q 20/102; G06Q 40/02

(57) ABSTRACT

A method and system detects and addresses abnormalities in a financial management system. The method and system include gathering financial data related to financial transactions of the users of the financial management system and generating profile data related to patterns in the financial transaction data by analyzing the financial transaction data. The method and system further include detecting abnormalities in the financial management system by comparing subsequent financial transaction data to the profile data.

### BACKGROUND

Every year millions of people around the world use electronic financial management systems to help manage their finances. Such financial management systems gather data related to financial transactions of the users. The users can monitor many or all of their financial transactions and other matters from a single financial management system. Such financial management systems can help users save time by eliminating the need to check several different financial accounts in order to manage the finances. However, many users can still encounter difficulties when using traditional financial management systems.

For instance, a financial management system may execute hundreds or thousands of independent processes, each responsible for aggregation of a particular type of data feed. These processes are run regularly and independently of each other and often have individual modes of failure. While there is a certain amount of monitoring and logging associated with each process, many errors go undetected. As a result, any subsequent processing of the aggregated data becomes difficult or impossible due to uneven and unknown data quality and lack of guarantee of completeness.

These failures can have tremendous adverse impact on users. Users may make financial decisions based on incomplete or erroneous data presented to them by their financial management system. A user may make purchases believing she has more money in her bank account than she truly has. A user may buy or sell stocks based on faulty information. This can potentially ruin a user's financial situation and have life-long consequences. Not only does this adversely affect the users, but to assist users with these situations financial management systems may need to devote large amount of human and computer resources to assist large numbers of users in resolving these issues. Additionally, users may feel that their financial management system did them more harm than good and may decide to abandon the financial management system.

What is needed is a method and system that provides more accurate and reliable financial management for users.

### SUMMARY

Embodiments of the present disclosure address some of the shortcomings associated with traditional financial management systems by providing methods and systems for detecting and addressing abnormalities in data collected by a financial management system. In particular, embodiments of the present disclosure gather financial transaction data related to financial transactions of users during a first period of time. Embodiments of the present disclosure analyze the financial transaction data gathered during a first period of time. Embodiments of the present disclosure generate profile data related to patterns, profiles, and archetypes found in the financial transaction data. Embodiments of the present disclosure gather financial transaction data related to financial transactions of users during a second period of time and compare the financial transaction data from the second period of time to the profile data. Embodiments of the present disclosure detect abnormalities in the financial transaction data collected during second period of time based on the comparison to the profile data. Embodiments of the present disclosure can identify potential errors or flaws in the data collection process and can make corrections so that users are not adversely affected. In this way, embodiments of the present disclosure provide a more reliable financial management system that increases user security and confidence.

In one embodiment, a financial management system includes a data acquisition module that gathers financial transaction data related to financial transactions of users of the financial management system. The financial management system also includes an analytics module that analyzes the financial transaction data gathered during a first period of time and generates profile data related to profiles, patterns, and/or archetypes found in the financial transaction data gathered during the first period of time. Subsequently, the analytics module analyzes financial transaction data collected by the data acquisition module during the second period of time and compares the financial transaction data collected by the data acquisition module during the second period of time to the profile data to identify large-scale departures from expected patterns based on the profile data. If an unexpectedly and improbably large number of users or accounts show changes, such as missing transactions that are expected based on the profile data, then the analytics module can determine that there is a problem with processes executed by the data acquisition module in acquiring the financial transaction data during the second period of time. The analytics module can generate correction data related to the detected abnormalities. The correction data can include a flag that indicates to the data acquisition module that there is a potential problem in the processes executed by the data acquisition module. Alternatively, the correction data can include corrective measures to be taken by the data acquisition module.

In one embodiment, the financial management system receives account data related to financial accounts that users have with third-party financial systems. The account data can include data that allows the financial management system to gain online access to the financial accounts of the users. The account data can include login information or other types of validation information such as usernames, passwords, bank account numbers, routing numbers, answers to security questions, identification numbers, Social Security numbers, or other information that can allow the financial management systems to access user accounts with third-party financial systems. Using the account data, the data acquisition module retrieves from the third-party financial systems financial transaction data related to the financial transactions of the users.

In one embodiment, the data acquisition module can execute hundreds or thousands of independent processes each responsible for aggregation of a particular type of data feed to supply or supplement the financial transaction data. Many data feeds contain regular events that are strictly periodic or have a consistent distribution in terms of time gaps between the events. This can be particularly true for financial transactions. It is possible that a regular pattern of transactions changes in a single account. This can occur when a user loses or misplaces a bill or merely forgets to pay. Scheduled transactions can fail as well; payroll can be late, tenants may be late with the rent, or users may forget to deposit a check. Stockbrokers' computer systems may get disconnected from a bank account, thereby delaying transfers. It is possible that some level of correlation in time of such event distribution changes may exist across multiple feeds for accounts. However, significant spikes in the correlation of the time of change across multiple accounts may indicate systemic aggregation failures. Furthermore the set of accounts that correlate on the time of missing regular events can be analyzed for common features to support root cause analysis. As an example, if the number of credit card accounts from a set of accounts associated with a particular bank that has undergone transaction distribution change at the same time is much higher than would be expected for a random sample of accounts, a likely root cause of such an event is related to the failure of the process responsible for acquiring and aggregating the feeds related to that bank.

Accordingly, in one embodiment, the analytics module is configured to analyze transaction data related to individual user accounts to detect when changes occur with respect to a pattern of events over time. The analytics module can use one or more algorithms; such as change point detection algorithms to analyze the financial transaction data. This can include analysis of even-time distribution that shows little or no variation, i.e. almost periodic. The analytics module can compute a total number of accounts that reached a change point at a given time. This number is expected to fluctuate moderately around some equilibrium value as long as changes in regular transaction time distribution is account specific. When the data acquisition module goes through systemic failure, there will be a significant spike in a number of accounts that reached a change point at a given time. The analytics module can detect such large-scale unexpected changes.

In one embodiment, the analytics module looks for events that should happen but do not happen. If an unexpectedly large number of such events do not happen at a given time, the analytics module detects an abnormality. This differs from some fraud detection systems that check for things like abnormally large amounts in a transaction, abnormal locations, unusual merchants, etc. Many regular transactions are difficult to track. However, the analytics module is configured to notice that the same regular transaction patterns sometimes occur inside the accounts of completely different users. The analytics module executes a data-driven algorithm that constructively adds up the small evidence available in single accounts such that the accumulated evidence is sufficient for reliable tracking and detection of large-scale abnormalities.

In one embodiment, the analytics module generates profile data related to common profiles, patterns, or archetypes in aggregate of financial transaction data. In particular, the analytics module is configured to analyze financial transaction data from many or all users to adaptively identify and track profiles, patterns, and archetypes in the financial transaction data. Such profiles, patterns, and archetypes, as represented by the profile data, may include transaction intervals, such as transactions that happen weekly, biweekly, monthly, quarterly, annually, etc. The profiles, patterns, and archetypes as represented by the profile data can include transaction amounts such as transactions that have exactly the same value or nearly the same value. The profiles, patterns, and archetypes as represented by the profile data can include transaction repetition run length such as those related to purchases that include a set number of consecutive monthly payments of the same amount. The profiles, patterns, and archetypes as represented by the profile data can include common merchant substring patterns. The profiles, patterns, and archetypes as represented by the profile data can include many other kinds of patterns that may occur in a large number of financial transactions.

In one example, the analytics module analyzes the financial transaction data and generates profile data indicating that a particular employer pays its employees on a biweekly basis. If subsequent financial transaction data indicates that a large number of users associated with that employer do not receive a paycheck, then the analytics module can determine that there is an abnormality and a possible error with the functionality of the data acquisition module with respect acquiring data related to that employer or a bank common to those users. In another example, the analytics module analyzes the financial transaction data and determines that the value of weekly loan payments is unexpectedly low or that such payments did not happen. The analytics module can determine that there is an abnormality and a possible error in the functionality of the data acquisition module with respect to acquiring data related to that particular bank. In one example, the analytics module analyzes the financial transaction data and generates profile data indicating that members of a particular gym pay quarterly dues. If subsequent financial transaction data indicates that a large number of users did not pay expected quarterly dues, then it is possible that there has been an error in the process for gathering financial transaction data related to that gym. Other examples can include patterns related to biannual car insurance payments or annual car registration payments. Many other kinds of patterns, profiles, and archetypes as represented by the profile data can be found and catalogued by the analytics module.

In one embodiment, the analytics module generates or refreshes profile data related to patterns, profiles, and archetypes found as a result of analyzing the financial transaction data over a first period of time, i.e. a day, a week, a month, a year, etc. As part of this process, the analytics module generates probability distributions related to intervals between transactions within approximately common merchant strings, approximately constant transaction amounts, and links of repetition runs, etc. From the computed distributions, the analytics module identifies transaction patterns, profiles, or archetype clusters by maximizing inter-cluster and maximizing inter-cluster distances. The analytics module then assigns identify profiles, patterns, or archetypes, as represented by the profile data, to user accounts based on the financial transaction data related to those user accounts in a first evaluation period of time. Such assignment of profiles, patterns, or archetypes to user accounts is carried out using a fitness score that combines factors such as how many transactions the profile, patterns, or archetype predicts that are not in the account and how many historical transactions have occurred that are not predicted by the profile, pattern, or archetype as represented by the profile data. The analytics module then measures the fitness score for a current evaluation period. By re-computing fitness scores for the current evaluation period the analytics module can transmit correction data to notify users when a profile, pattern, or archetype assigned to them is violated, as long as the total number of violations for that profile, pattern, or archetype is not unusual. This can be determined with respect to specific user accounts from past evaluation periods, with respect to the current evaluation for a selected profile, pattern, or archetype across all accounts, or with respect to the selected profile, pattern, or archetypes from past evaluation periods. If the total number of violations of the selected profile, pattern, or archetype as represented by the profile data has an unexpected jump, then the analytics module transmits correction data to the data acquisition module and/or the script engine indicating that certain scripts are dropping transactions and that once the scripts are fixed, a selective historical refresh should be performed over the time frame for which an error is suspected.

Embodiments of the present disclosure address some of the shortcomings associated with traditional financial management systems that do not adequately detect and address abnormalities in the financial management system. A financial manager system in accordance with one or more embodiments provides confidence to a user by quickly detecting and addressing abnormalities in the financial management system. The various embodiments of the disclosure can be implemented to improve the technical fields of user experience, services marketing, data collection, and data processing. Therefore, the various described embodiments of the disclosure and their associated benefits amount to significantly more than an abstract idea. In particular, by detecting and addressing abnormalities in a financial management system, users can save money and time and can better manage their finances.

Using the disclosed embodiments of a method and system for detecting and addressing abnormalities in a financial management system, a method and system for detecting and addressing abnormalities in a financial management system more accurately is provided. Therefore, the disclosed embodiments provide a technical solution to the long standing technical problems of providing reliable and secure financial management services for users of a financial management system.

In addition, the disclosed embodiments of a method and system for detecting and addressing abnormalities in a financial management system are also capable of dynamically adapting to the needs of users of a financial management system. Consequently, the disclosed embodiments of a method and system for detecting and addressing abnormalities in a financial management system also provide a technical solution to the long standing technical problem of static and inflexible financial management systems.

The result is a much more accurate, adaptable, and robust, method and system for detecting and addressing abnormalities in a financial management system, but thereby serves to bolster confidence in electronic financial management systems. This, in turn, results in: less human and processor resources being dedicated to analyzing electronic financial transactions because more accurate and efficient analysis methods can be implemented, i.e., fewer processing and memory storage assets; less memory and storage bandwidth being dedicated to buffering and storing financial transaction data; less communication bandwidth being utilized to transmit financial transaction data for data for analysis.

The disclosed method and system for detecting and addressing abnormalities in a financial management system does not encompass, embody, or preclude other forms of innovation in the area of electronic financial management. In addition, the disclosed method and system for detecting and addressing abnormalities in a financial management system is not related to any fundamental economic practice, fundamental data processing practice, mental steps, or pen and paper based solutions, and is, in fact, directed to providing solutions to new and existing problems associated with electronic financial management systems. Consequently, the disclosed method and system for detecting and addressing abnormalities in a financial management system, does not encompass, and is not merely, an abstract idea or concept.

### BRIEF DESCRIPTION OF THE DRAWINGS

FIG. 1 is a block diagram of software architecture for detecting and addressing abnormalities in a financial management system, in accordance with one embodiment.

FIG. 2 is a block diagram of a process for detecting and addressing abnormalities in a financial management system, in accordance with one embodiment.

FIG. 3 is a flow diagram of a process for detecting and addressing abnormalities in a financial management system, in accordance with one embodiment.

FIG. 4 is a block diagram of a process for detecting and addressing abnormalities in a financial management system, in accordance with one embodiment.

FIG. 5 is a flow diagram of a process for detecting and addressing abnormalities in a financial management system, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed financial management system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

### Hardware Architecture

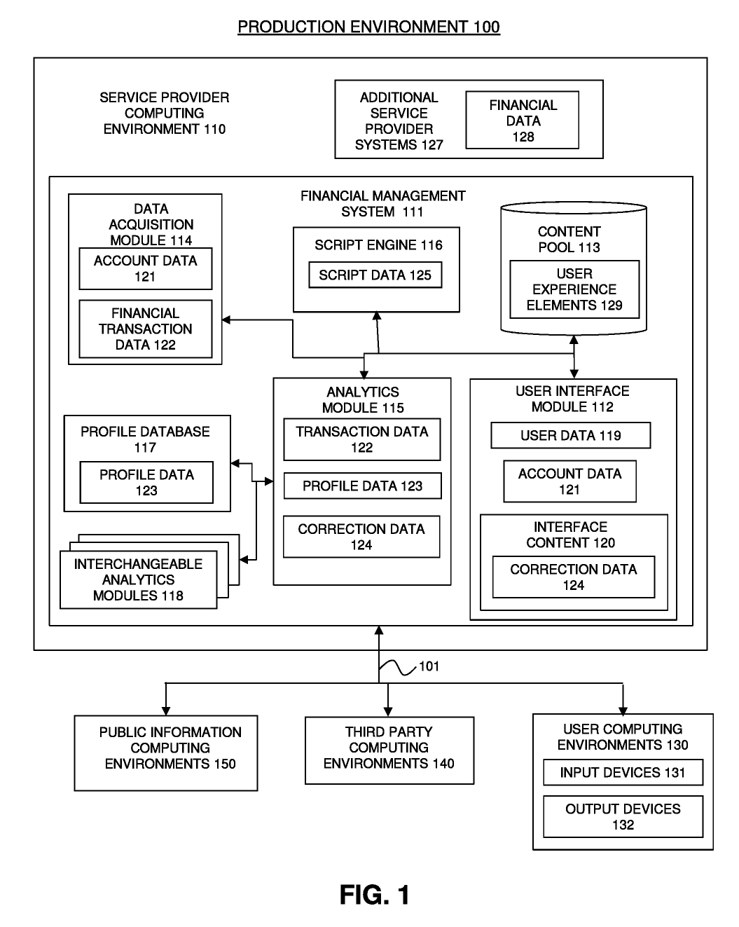

FIG. 1 illustrates a block diagram of a production environment 100 for detecting and addressing abnormalities in a financial management system, according to one embodiment. Embodiments of the present disclosure provide methods and systems for detecting and addressing abnormalities in a financial management system, according to one embodiment. In particular, embodiments of the present disclosure analyze financial transaction data related to financial transactions of users during a first period of time and generate profile data related to a plurality of profiles, patterns, and/or archetypes within the financial transaction data. Embodiments then compare financial transaction data related to financial transactions in a second period of time to the profile data in order to detect abnormalities in the financial transaction data gathered in the second period of time. These abnormalities can indicate problems with internal data acquisition processes or scripts run by the financial management system. These abnormalities can also relate to errors or mistakes made by one or more users. Embodiments take steps to address the abnormalities to improve functionality of the financial management system and/or to alert users to possible mistakes on their part. By detecting abnormalities and taking corrective steps, user confidence in the financial management system is increased.

In addition, the disclosed method and system for detecting and addressing abnormalities in a financial management system provides for significant improvements to the technical fields of electronic financial transaction data processing, data processing, data management, and user experience.

In addition, as discussed above, the disclosed method and system for detecting and addressing abnormalities in a financial management system provide for the processing and storing of smaller amounts of data, i.e., more efficiently acquire and analyze financial data; thereby eliminating unnecessary data analysis and storage. Consequently, using the disclosed method and system for detecting and addressing abnormalities in a financial management system results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for detecting and addressing abnormalities in a financial management system.

The production environment 100 includes a service provider computing environment 110, user computing environments 130, third party computing environments 140, and public information computing environments 150, for detecting and addressing abnormalities in a financial management system, according to one embodiment. The computing environments 110, 130, 140, and 150 are communicatively coupled to each other with one or more communication channels 101, according to one embodiment.

The service provider computing environment 110 represents one or more computing systems such as a server, a computing cabinet, and/or distribution center that is configured to receive, execute, and host one or more tax return preparation systems (e.g., applications) for access by one or more users, for detecting and addressing abnormalities in a financial management system, according to one embodiment. The service provider computing environment 110 represents a traditional data center computing environment, a virtual asset computing environment (e.g., a cloud computing environment), or a hybrid between a traditional data center computing environment and a virtual asset computing environment, according to one embodiment.

The service provider computing environment 110 includes a financial management system 111, which is configured to provide financial management services to a user.

According to one embodiment, the financial management system 111 can be a system that manages one or more of banking, investments, loans, credit cards, real estate investments, retirement planning, bill pay, and budgeting. The financial management system 111 can be a tax return preparation systems or other type of financial management system. The financial management system 111 can be a standalone system that provides financial management services to users. Alternatively, the financial management system 111 can be integrated into other software or service products provided by a service provider.

The financial management system 111 receives user financial transaction data related to financial transactions of a plurality of users over a first period of time and generates profile data related to common patterns, profiles, and/or archetypes in the financial transaction data. The financial management system 111 then gathers financial transaction data related to financial transactions in a second period of time and compares the financial transaction data from the second period of time to the profile data. The financial management system 111 detects abnormalities in the transaction data based on differences between the transaction data and the profiles. The financial management system 111 then generates correction data related to the abnormalities. The financial management system 111 can use the correction data to correct internal process and scripts and/or to notify users of potential errors, according to one embodiment. The financial management system 111 includes various components, databases, engines, modules, and/or data to support detecting abnormalities in a financial management system.

In one embodiment, the financial management system 111 detects abnormalities by finding a correlation of change points across user accounts that are not expected to correlate. The financial management system then performs root cause analysis to determine the root causes of the abnormalities. Performing root cause analysis on these accounts enables the financial management system 111 to find what attributes within the group of user accounts that correlates on change point occurrences are different from a random sample from the entire population of user accounts. In this way, the financial management system 111 can determine the root causes of the abnormalities.

The financial management system 111 includes a user interface module 112, a content pool 113, a data acquisition module 114, an analytics module 115, a script engine 116, a profile database 117, and an interchangeable analytics module 118, according to one embodiment.

The user interface module 112 can enable users to access their data, choose their data, receive assistance in using the financial management system, etc. The user interface module 112 receives user data 119 and account data 121 in response to providing interface content 120, according to one embodiment. The user interface module 112 populates interface content 120 from a content pool 113 including financial topics that can be presented with one or more user experience elements 129, according to one embodiment. The interface content can enable a user to select what kind of data to provide to or receive from the financial management system 111. The user experience elements 129 include, but are not limited to, buttons, slides, dialog boxes, text boxes, drop-down menus, banners, tabs, directory trees, links, audio content, video content, and/or other multimedia content for receiving user data 119 and account data 121 from the user computing environments 130 and for providing questions, financial management data, and correction data to the user computing environments 130, according to one embodiment

The user computing environments 130 can each include input devices 131 and output devices 132 for communicating with users, according one embodiment. The input devices 131 include, but are not limited to, keyboards, mice, microphones, touchpads, touchscreens, digital pens, and the like. The output devices 132 include, but are not limited to, speakers, monitors, touchscreens, and the like. The output devices 132 can display the financial management data and correction data 124 to the user.

Returning to the financial management system 111, the user interface module 112 is configured to receive user data 119 and account data 121 from the users, according to one embodiment. The user data 119 includes information, such as, but not limited to first and last names of users, addresses of users, usernames of users, identification numbers of users, passwords of users, and other data used by the financial management system to identify users.

In one embodiment, the account data 121 data provided by the users enables the financial management system 111 to acquire information related to financial transactions of the users. The account data 121 can include data that allows the financial management system 111 to gain access to credit card data, bank account data, retirement fund data, payroll data, income data, loan data, interest accrual data, student loan data, property ownership data, tax data, budgeting data, rent data, investments data, employment data, or other types of data regarding financial transactions or financial accounts of the users. Thus, the account data 121 can include login credentials and personal identification data for various websites of third-party financial institutions. The account data 121 can include usernames, passwords, bank account numbers, routing numbers, credit card numbers, answers to security questions, identification numbers, government identification numbers, birth dates, addresses, or other types of verification credentials that allow the financial management system 111 to gain access to online services of third-party financial service institutions.

The data acquisition module 114 is configured to use the account data 121 to acquire financial transaction data 122 related to financial transactions of the users. In particular, the data acquisition module 114 uses the account data 121 to log into the online services of third-party financial institutions in order to retrieve financial transaction data 122 related to the financial transactions of users of the financial management system 111. For example, the financial transaction data 122 can include bank account deposits, bank account withdrawals, credit card transactions, credit card balances, credit card payment transactions, online payment service transactions such as PayPal transactions or other online payment service transactions, loan payment transactions, investment account transactions, retirement account transactions, mortgage payment transactions, rent payment transactions, bill pay transactions, budgeting information, financial goal information, or any other types of financial transactions. The data acquisition module 114 is configured to gather the financial transaction data from third-party computing environments 140 related to financial service institutions with which one or more users of the financial management system 111 have a relationship.

In one example, the data acquisition module 114 uses the account data 121 to acquire data related to withdrawals, deposits, and balances in the bank accounts of users. The financial transaction data 122 includes data related to these withdrawals, deposits, and balances. Accordingly, the account data 121 can include usernames, passwords, bank account numbers, routing numbers, or other validation credentials needed to access online services of various banking institutions.

In one embodiment, the data acquisition module 114 can also supply or supplement the financial transaction data 122 by gathering financial transaction data from other sources including public information computing environment 150, the additional service provider systems 127, data provided by the user, data collected from user devices or accounts of the financial management system 111, social media accounts, and/or various other sources to merge with or supplement financial transaction data 122, according to one embodiment. The data acquisition module 114 can gather additional data including historical tax related data and third party data. For example, the data acquisition module 114 is configured to communicate with additional service provider systems 127, e.g., a tax return preparation system, a payroll management system, or other financial management system, to access financial data 128, according to one embodiment. The data acquisition module 114 imports relevant portions of the financial data 128 into the financial management system 111 and, for example, saves local copies into one or more databases, according to one embodiment.

In one embodiment, the additional service provider systems 127 include a personal financial management system, and the data acquisition module 114 is configured to acquire financial data 128 for use by the financial management system 111 in providing financial management services to the user, according to one embodiment. Because the services provider provides both the financial management system 111 and, for example, the additional service provider systems 127, the service provider computing environment 110 can be configured to share financial information between the various systems. By interfacing with the additional service provider systems 127, the data acquisition module 114 can collect financial data 128. The financial data 128 can include income data, investment data, property ownership data, retirement account data, age data, data regarding additional sources of income, marital status, number and ages of children or other dependents, geographic location, and other data that indicates personal and financial characteristics of users of other financial systems, according to one embodiment.

According to one embodiment, the data acquisition module 114 can obtain some or all of the financial transaction data from one or more common databases of the financial management system 111. The common databases can include one or more databases in which user data 119, account data 121, financial transaction data 122, and/or historical tax related data is stored. The common databases can also store other data that can supplement the user data 119, account data 121, and financial transaction data 122 acquired by the data acquisition module 114.

The data acquisition module 114 is configured to acquire additional financial data from the public information computing environment 150, according to one embodiment. The financial transaction data 122 can be gathered from public record searches of tax records, public information databases, property ownership records, and other public sources of information. The data acquisition module 114 can also acquire data from sources such as social media websites, such as Twitter, Facebook, LinkedIn, and the like.

The data acquisition module 114 is configured to acquire data from third parties, according to one embodiment. For example, the data acquisition module 114 requests and receives from the third party computing environments 140 to supply or supplement the financial transaction data 122, according to one embodiment. In one embodiment, the third party computing environment 140 is configured to automatically transmit financial data to the financial management system 111 (e.g., to the data acquisition module 114), to be merged into the financial transaction data 122. The third party computing environment 140 can include, but is not limited to, financial service providers, state institutions, federal institutions, private employers, financial institutions, social media, and any other business, organization, or association that has maintained financial data, that currently maintains financial data, or which may in the future maintain financial data, according to one embodiment.

In one embodiment, the data acquisition module 114 acquires the financial transaction data 122 by executing instructions, processes, and/or scripts under the control of a script engine 116. The script engine 116 includes script data 125 related to a plurality of instructions, processes, and/or scripts to be executed by the data acquisition module 114 in order to obtain and organize the financial transaction data 122. The script data 125 can include data related to instructions, processes, and/or scripts that determine the frequency with which the data acquisition module 114 acquires financial transaction data 122, the time or times of day at which the data acquisition module 114 acquires additional financial transaction data 122, the login procedures the data acquisition module 114 uses when accessing financial transaction data 122 from third party computing environments 140, and other scripts related to the way the data acquisition module 114 accesses financial transaction data 122.

In one embodiment, errors or deficiencies in the script data 125 can occasionally cause the data acquisition module 114 to fail to properly acquire the financial transaction data 122. This can manifest as a wholesale failure to acquire financial transaction data from a particular financial institution on a particular day, as a failure to properly analyze and organize the financial transaction data 122 received from a particular financial institution, or many other ways in which data acquisition module 114 can fail to properly obtain, categorize, output, or present the financial transaction data 122.

In one embodiment, the financial management system 111 uses the analytics module 115 to analyze the transaction data 122 in order to detect abnormalities related to failures or errors made by the data acquisition module 114 in properly retrieving, categorizing, organizing, outputting, and/or presenting the financial transaction data 122. In particular, the analytics module 115 can analyze the financial transaction data 122 from a first period of time in order to generate profile data 123 relating to common profiles, patterns, and/or archetypes found in the financial transaction data 122. The profile data 123 relates to common patterns or characteristics in the financial data 122. After the analytics module 115 has generated profile data 123 related to financial transaction data 122 from the first period of time, the analytics module 115 analyzes transaction data 122 from a second period of time after the first period of time and compares the transaction data 122 from the second period of time to the profile data 123. The analytics module 115 is configured to execute one or more algorithms to detect abnormalities in the transaction data 122 from the second time period based on differences between the transaction data 122 and the profile data 123. These abnormalities can indicate errors or failures by the data acquisition module 114 in properly gathering the financial transaction data 122. Alternatively, the abnormalities can indicate that one or more of the users has made an error or omission in one or more financial transactions.

In one embodiment, the analytics module 115 generates correction data 124 based on the abnormalities. The correction data 124 may merely flag a potential error failure. Alternatively, the correction data 124 can include corrections to be made by the data acquisition module 114 or the script engine 116 in order to properly acquire financial transaction data 122. The correction data 124 can also include a notification to be provided to one or more users of the financial management system 111 indicating a possible error made by the user or the financial management system 111.

In one embodiment, the data acquisition module 114 can execute hundreds or thousands of independent processes each responsible for aggregation of a particular type of data feed to supply or supplement the financial transaction data 122. These processes are run regularly and independently of each other and often have independent modes of failure. If an error occurs in one or more of the processes, it can become very difficult to properly acquire, aggregate, consolidate, organize, process, output, and/or provide the financial transaction data 122.

Many data feeds contain regular events that are strictly periodic or have a consistent distribution in terms of time gaps between the events. This can be particularly true for financial transactions. It is possible that a regular pattern of transactions changes in a single account. This can occur when a user loses or misplaces a bill or merely forgets to pay. Scheduled transactions can fail as well; payroll can be late, tenants may be late with the rent, or users may forget to deposit a check. Stockbrokers' computer systems may get disconnected from a bank account, thereby delaying transfers. It is possible that some level of correlation in time of such event distribution changes may exist across multiple feeds for accounts. However, significant spikes in the correlation of the time of change across multiple accounts may indicate systemic aggregation failures. Furthermore the set of accounts that correlate on the time of missing regular events can be analyzed for common features to support root cause analysis. As an example, if the number of credit card accounts from a set of accounts associated with a particular bank that has undergone transaction distribution change at the same time is much higher than would be expected for a random sample of accounts, a likely root cause of such an event is related to the failure of the process responsible for acquiring and aggregating the feeds related to that bank.

Accordingly, in one embodiment, the analytics module 115 is configured to analyze transaction data 122 related to individual user accounts to detect when a change in the distribution over time of regular events occurs the analytics module 115 can use one or more algorithms, such as change point detection algorithms to analyze the financial transaction data 122. This can include analysis of event time distribution that shows little or no variation, i.e. almost periodic. The analytics module 115 can compute a total number of accounts that reached a change point at a given time. This number is expected to fluctuate moderately around some equilibrium value as long as changes in regular transaction time distribution is account specific. When the data acquisition module 114 goes through systemic failure, there will be a significant spike in a number of accounts that reached a change point at a given time. The analytics module 115 can detect such large-scale unexpected changes.

Thus, in one embodiment, the analytics module 115 looks for events that should happen but do not happen. If an unexpectedly large number of such events do not happen at a given time, the analytics module 115 detects an abnormality. This differs from some fraud detection systems that check for things like abnormally large amounts in a transaction, abnormal locations, unusual merchants, etc.

For the reasons given above, many regular transactions are difficult to track. However, the analytics module 115 is configured to notice that the same regular transaction patterns sometimes occur inside the accounts of completely different users. The analytics module 115 executes a data-driven algorithm that constructively adds up the small evidence available in single accounts such that the accumulated evidence is sufficient for reliable tracking and detection of large-scale abnormalities.

In one embodiment, the analytics module 115 generates profile data 123 related to common profiles, patterns, and/or archetypes in aggregate of financial transaction data 122. In particular, the analytics module 115 is configured to analyze financial transaction data 122 from many or all users to adaptively identify and track profiles, patterns, and/or archetypes in the financial transaction data 122. Such profiles, patterns, and/or archetypes, as represented by the profile data 123, may include transaction intervals, such as transactions that happen weekly, biweekly, monthly, quarterly, annually, etc. The profiles, patterns, and archetypes as represented by the profile data 123 can include transaction amounts such as transactions that have exactly the same value or nearly the same value. The profiles, patterns, and archetypes as represented by the profile data 123 can include transaction repetition run length such as those related to purchases that include a set number of consecutive monthly payments of the same amount. The profiles, patterns, and archetypes as represented by the profile data 123 can include common merchant substring patterns. The profiles, patterns, and archetypes as represented by the profile data 123 can include many other kinds of patterns that may occur in a large number of financial transactions.

In one example, the analytics module 115 analyzes the financial transaction data 122 and generates profile data 123 indicating that a particular employer pays its employees on a biweekly basis. If subsequent financial transaction data 122 indicates that a large number of users associated with that employer do not receive a paycheck, then the analytics module 115 can determine that there is an abnormality and a possible error with the functionality of the data acquisition module with respect acquiring data related to that employer or a bank common to those users. In another example, the analytics module 115 analyzes the financial transaction data 122 and determines that the value of weekly loan payments is unexpectedly low or that such payments did not happen. The analytics module 115 can determine that there is an abnormality and a possible error in the functionality of the data acquisition module with respect to acquiring data related to that particular bank.

In one example, the analytics module 115 analyzes the financial transaction data and generates profile data 123 indicating that members of a particular gym pay quarterly dues. If subsequent financial transaction data 122 indicates that a large number of users did not pay expected quarterly dues, then the analytics module 115 may conclude that there has been an error in the process for gathering financial transaction data 122 related to that gym. Other examples can include patterns related to biannual car insurance payments or annual car registration payments. Many other kinds of patterns, profiles, and/or archetypes as represented by the profile data 123 can be found and catalogued by the analytics module 115.

In one embodiment, the analytics module generates or refreshes profile data 123 related to patterns, profiles, and/or archetypes found as a result of analyzing the financial transaction data 122 over a first period of time, i.e. a day, a week, a month, a year, etc. As part of this process, the analytics module generates probability distributions related to intervals between transactions within approximately common merchant strings, approximately constant transaction amounts, and lengths of repetition runs, etc. From the computed distributions, the analytics module 115 identifies transaction patterns, profiles, or archetype clusters by maximizing inter-cluster and minimizing intra-cluster distances. The analytics module 115 then assigns profiles, patterns, or archetypes as represented by the profile data 123 to user accounts based on those user accounts' transaction histories in a first evaluation period of time. Such assignment of profiles, patterns, or archetypes to user accounts is carried out using a fitness score that combines factors such as how many transactions are predicted that are not in the account and how many historical transactions have occurred that are not predicted by the profile, pattern, and/or archetype as represented by the profile data 123. The analytics module then measures the fitness for a current evaluation by re-computing fitness scores for the current evaluation period. The analytics module 115 can transmit correction data 124 to notify users when a profile, pattern, and/or archetype assigned to them is violated, as long as the total number of violations for that profile, pattern, and/or archetype is not unusual. This can be determined with respect to specific user accounts from past evaluation periods, with respect to the current evaluation period, for a selected profile, pattern, and/or archetype across all accounts, or with respect to the selected profile, pattern, or archetypes history from past evaluation periods. If the total number of violations of the selected profile, pattern, and/or archetype as represented by the profile data 123 has an unexpected jump then the analytics module 115 transmits correction data 124 to the data acquisition module 114 and or the script engine 116. The correction data 124 may indicate that certain scripts are dropping transactions and that once the scripts or processes are fixed, a selective historical refresh should be performed over the timeframe for which an error is suspected.

In one embodiment, the analytics module 115 performs segmentation analysis on the financial transaction data from a first period of time. The segmentation analysis finds segments or patterns in the financial transaction data 122 from the first period of time. The analytics module 115 generates profile data 123 representing the segments or patterns found in the financial transaction data 122 from the first period of time.

In one embodiment, the data acquisition module 114 can retrieve financial transaction data 122 related to hundreds of millions of financial transactions in a given month or year. The transaction data for single transaction can include a large number of types of data. For example, the transaction data from a single transaction can include a transaction number, a reference number, payee name and/or identification number, a payer name and/or identification number, a credit card and/or account number, and address, payment method, a date and time, a monetary amount and unit, scraping errors, token merges, data duplication, and data truncation. In one example, a single grocery store transaction can be represented by more than 300 types of data.

In one embodiment, the analytics module 115 can find approximate patterns representing distributions of payment dates, payment amounts, payment frequencies, payment rounds, etc. The analytics module 115 can calculate probabilities of a particular type of transaction occurring on or around the given date. The distribution of a certain type of payment may indicate that it happens biweekly. The analytics module 115 can calculate the probability that a payment will occur within a particular number of days and if a large number of such payments do not occur within the expected payment, then the analytics module 115 can determine that an error has occurred with respect to the data acquisition module 114 and/or the script engine 116.

In one embodiment, the analytics module 115 generates the profile data 123 and/or detects abnormalities by using predictive models. The predictive models can include an algorithm using modeling techniques selected from the group including logistic regression, naïve bays, K means classification, K means clustering, other clustering techniques, K nearest neighbor, neural networks, decision trees, random forests, boosted trees, k-nn classification, kd trees, generalized linear models, support vector machines, and substantial equivalents thereof. The analytics module 115 can also utilize other suitable techniques for generating the profile data 123 and/or detecting abnormalities in the financial transaction data 122.

In one embodiment, the financial management system 111 includes a plurality of interchangeable analytics modules 118 and an analytics selection engine. The analytics module selection engine selects the analytics module 115 from among the interchangeable analytics modules 118 based on the currently received financial transaction data 122. The analytics module selection engine can select a different analytics module from the interchangeable analytics modules based on particular circumstances. The financial management system 111 then uses the selected analytics module 115 to generate the profile data 123 and/or to compare financial transaction data 122 to the profile data 123 in order to detect abnormalities in the financial transaction data 122.

In one embodiment, the analytics module 115 generates the profile data 123 by analyzing financial transaction data 122 from a first evaluation period of time. The analytics module 115 then detects abnormalities in the transaction data 122 from a second evaluation period of time by comparing the financial transaction data from the second period of time to the profile data 123. The analytics module 115 can update the profile data 123 based on the financial transaction data 122 received during the second evaluation period of time. Thus, the analytics module 115 can refresh or update the profile data 123 in subsequent evaluation periods of time. The analytics module 115 can generate profile data 123 corresponding to newly found patterns, profiles and/or archetypes in the transaction data 122 from an additional evaluation period of time.

In one embodiment, the analytics module 115 stores the generated profile data 123 in the profile database 117. After the analytics module 115 has generated profile data 123, the analytics module 115 can retrieve the profile data 123 at any time to analyze new transaction data 122 based on the profile data 123 or to update the profile data 123.

Embodiments of the present disclosure address some of the shortcomings associated with traditional financial management systems that do not adequately detect and address errors and abnormalities in the financial management systems. A financial management system in accordance with one or more embodiments provides more reliable financial management services by analyzing financial transaction data to detect patterns and abnormalities in the financial transaction data. The various embodiments of the disclosure can be implemented to improve the technical fields of user experience, services marketing, data collection, and data processing. Therefore, the various described embodiments of the disclosure and their associated benefits amount to significantly more than an abstract idea. In particular, by detecting and addressing abnormalities in the financial management system, users of the financial management systems can save money and time and can better manage their finances.

### Process

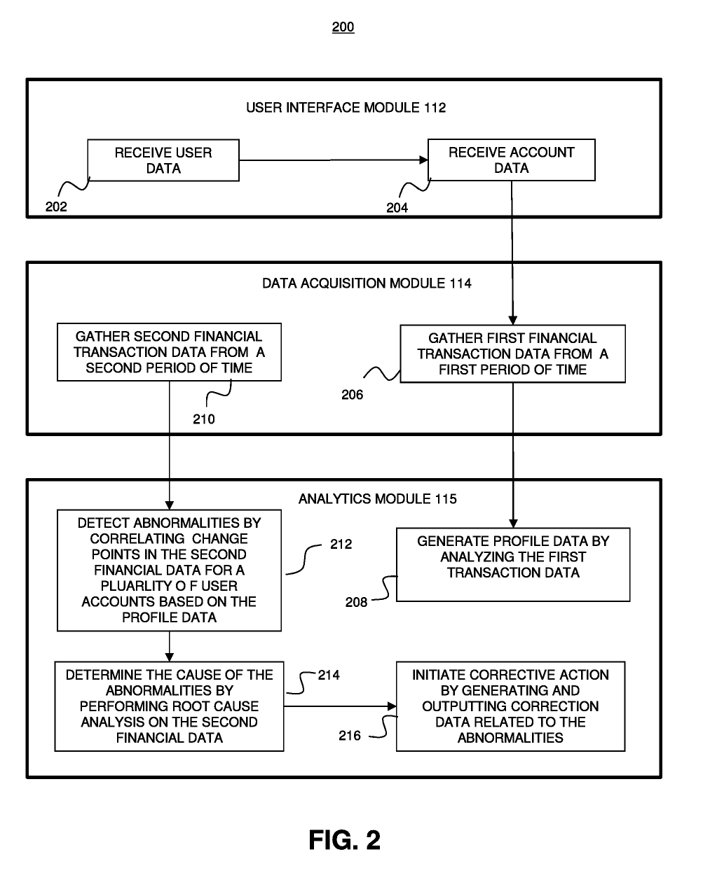

FIG. 2 illustrates a functional flow diagram of a process 200 for detecting and addressing abnormalities in a financial management system, in accordance with one embodiment.

At block 202, the user interface module 112 receives user data related to a plurality of users of a financial management system, according to one embodiment. From block 202 the process proceeds to block 204.

At block 204, the user interface module 112 receives account data related to a plurality of third-party financial accounts of the users, according to one embodiment. From block 204 the process proceeds to block 206.

At block 206, the data acquisition module 114 gathers first financial transaction data related to a plurality of financial transactions of the users from a first period of time, according to one embodiment. From block 206 the process proceeds to block 208.

At block 208, the analytics module 115 generates profile data by analyzing the first financial transaction data, according to one embodiment.

At block 210, the data acquisition module 114 gathers second financial transaction data related to financial transactions of the users from a second period of time, according to one embodiment. From block 210 the process proceeds to block 212.

At block 212, the analytics module 115 detects abnormalities by correlating change points in the second financial data for a plurality of user accounts based on the profile data, according to one embodiment. From block 212 the process proceeds to block 214.

At block 214 the analytics module 115 determines the cause of the abnormalities by performing root cause analysis on the second financial data, according to one embodiment. From block 214 the process proceeds to block 216.

At block 216 the analytics module 115 initiates corrective action by generating and outputting correction data related to the abnormalities, according to one embodiment.

Although a particular sequence is described herein for the execution of the process 200, other sequences can also be implemented.

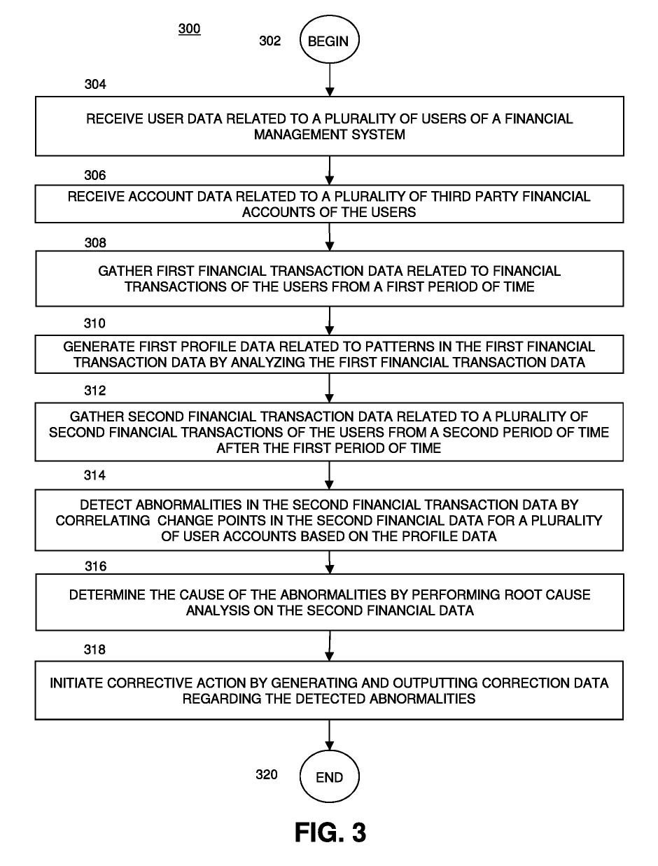

FIG. 3 illustrates a flow diagram of a process 300 for detecting and addressing abnormalities in a financial management system, according to various embodiments.

In one embodiment, process 300 for detecting and addressing abnormalities in a financial management system begins at BEGIN 302 and process flow proceeds to RECEIVE USER DATA RELATED TO A PLURALITY OF USERS OF A FINANCIAL MANAGEMENT SYSTEM 304.

In one embodiment, at RECEIVE USER DATA RELATED TO A PLURALITY OF USERS OF A FINANCIAL MANAGEMENT SYSTEM 304 process 300 for detecting and addressing abnormalities in a financial management system receives user data related to a plurality of users of a financial system.

In one embodiment, once process 300 for detecting and addressing abnormalities in a financial management system receives user data related to a plurality of users of a financial system at RECEIVE USER DATA RELATED TO A PLURALITY OF USERS OF A FINANCIAL MANAGEMENT SYSTEM 304 process flow proceeds to RECEIVE ACCOUNT DATA RELATED TO A PLURALITY OF THIRD PARTY FINANCIAL ACCOUNTS OF THE USERS 306.

In one embodiment, at RECEIVE ACCOUNT DATA RELATED TO A PLURALITY OF THIRD PARTY FINANCIAL ACCOUNTS OF THE USERS 306, process 300 for detecting and addressing abnormalities in a financial management system receives account data related to a plurality of third party financial accounts of the users.

In one embodiment, once process 300 for detecting and addressing abnormalities in a financial management system receives account data related to a plurality of third party financial accounts of the users at RECEIVE ACCOUNT DATA RELATED TO A PLURALITY OF THIRD PARTY FINANCIAL ACCOUNTS OF THE USERS 306, process flow proceeds to GATHER FIRST FINANCIAL TRANSACTION DATA RELATED TO FINANCIAL TRANSACTIONS OF THE USERS FROM A FIRST PERIOD OF TIME 308.

In one embodiment, at GATHER FIRST FINANCIAL TRANSACTION DATA RELATED TO FINANCIAL TRANSACTIONS OF THE USERS FROM A FIRST PERIOD OF TIME 308, process 300 for detecting and addressing abnormalities in a financial management system gathers first financial transaction data related to financial transactions of the users from a first period of time, according to one embodiment.

In one embodiment, once process 300 for detecting and addressing abnormalities in a financial management system gathers first financial transaction data related to financial transactions of the users from a first period of time at GATHER FIRST FINANCIAL TRANSACTION DATA RELATED TO FINANCIAL TRANSACTIONS OF THE USERS FROM A FIRST PERIOD OF TIME 308, process flow proceeds to GENERATE FIRST PROFILE DATA RELATED TO PATTERNS IN THE FIRST FINANCIAL TRANSACTION DATA BY ANALYZING THE FIRST FINANCIAL TRANSACTION DATA 310.

In one embodiment, at GENERATE FIRST PROFILE DATA RELATED TO PATTERNS IN THE FIRST FINANCIAL TRANSACTION DATA BY ANALYZING THE FIRST FINANCIAL TRANSACTION DATA 310 the process 300 generates first profile data related to patterns in the first financial transaction data by analyzing the first financial transaction data.

In one embodiment, once process 300 generates first profile data related to patterns in the first financial transaction data by analyzing the first financial transaction data at GENERATE FIRST PROFILE DATA RELATED TO PATTERNS IN THE FIRST FINANCIAL TRANSACTION DATA BY ANALYZING THE FIRST FINANCIAL TRANSACTION DATA 310, process flow proceeds to GATHER SECOND FINANCIAL TRANSACTION DATA RELATED TO A PLURALITY OF SECOND FINANCIAL TRANSACTIONS OF THE USERS FROM A SECOND PERIOD OF TIME AFTER THE FIRST PERIOD OF TIME 312.

In one embodiment, at GATHER SECOND FINANCIAL TRANSACTION DATA RELATED TO A PLURALITY OF SECOND FINANCIAL TRANSACTIONS OF THE USERS FROM A SECOND PERIOD OF TIME AFTER THE FIRST PERIOD OF TIME 312 the process 300 for detecting and addressing abnormalities in a financial management system gathers second financial transaction data related to a plurality of second financial transactions of the users from a second period of time after the first period of time.

In one embodiment, once the process 300 for detecting and addressing abnormalities in a financial management system gathers second financial transaction data related to a plurality of second financial transactions of the users from a second period of time after the first period of time at GATHER SECOND FINANCIAL TRANSACTION DATA RELATED TO A PLURALITY OF SECOND FINANCIAL TRANSACTIONS OF THE USERS FROM A SECOND PERIOD OF TIME AFTER THE FIRST PERIOD OF TIME 312, process flow proceeds to DETECT ABNORMALITIES IN THE SECOND FINANCIAL TRANSACTION DATA BY CORRELATING CHANGE POINTS IN THE SECOND FINANCIAL DATA FOR A PLURALITY OF USER ACCOUNTS BASED ON THE PROFILE DATA 314.

In one embodiment, at DETECT ABNORMALITIES IN THE SECOND FINANCIAL TRANSACTION DATA BY CORRELATING CHANGE POINTS IN THE SECOND FINANCIAL DATA FOR A PLURALITY OF USER ACCOUNTS BASED ON THE PROFILE DATA 314 the process 300 for detecting and addressing abnormalities in a financial management system detects abnormalities in the second financial transaction data by correlating change points in the second financial data for a plurality of user accounts based on the profile data.

In one embodiment, once the process 300 for detecting and addressing abnormalities in a financial management system detects abnormalities in the second financial transaction data by correlating change points in the second financial data for a plurality of user accounts based on the profile data at DETECT ABNORMALITIES IN THE SECOND FINANCIAL TRANSACTION DATA BY CORRELATING CHANGE POINTS IN THE SECOND FINANCIAL DATA FOR A PLURALITY OF USER ACCOUNTS BASED ON THE PROFILE DATA 314, process flow proceeds to DETERMINE THE CAUSE OF THE ABNORMALITIES BY PERFORMING ROOT CAUSE ANALYSIS ON THE SECOND FINANCIAL DATA 316.

In one embodiment, at DETERMINE THE CAUSE OF THE ABNORMALITIES BY PERFORMING ROOT CAUSE ANALYSIS ON THE SECOND FINANCIAL DATA 316, the process 300 for detecting and addressing abnormalities in a financial management system determines the cause of the abnormalities by performing root cause analysis on the second financial data.

In one embodiment, once the process 300 for detecting and addressing abnormalities in a financial management system determines the cause of the abnormalities by performing root cause analysis on the second financial data at DETERMINE THE CAUSE OF THE ABNORMALITIES BY PERFORMING ROOT CAUSE ANALYSIS ON THE SECOND FINANCIAL DATA 316 process flow proceeds to INITIATE CORRECTIVE ACTION BY GENERATING AND OUTPUTTING CORRECTION DATA REGARDING THE DETECTED ABNORMALITIES 318.

In one embodiment, at INITIATE CORRECTIVE ACTION BY GENERATING AND OUTPUTTING CORRECTION DATA REGARDING THE DETECTED ABNORMALITIES 318 the process 300 for detecting and addressing abnormalities in a financial management system initiates corrective action by generating and outputting correction data regarding the detected abnormalities.

In one embodiment, once the process 300 for detecting and addressing abnormalities in a financial management system initiates corrective action by generating and outputting correction data regarding the detected abnormalities at INITIATE CORRECTIVE ACTION BY GENERATING AND OUTPUTTING CORRECTION DATA REGARDING THE DETECTED ABNORMALITIES 318, process flow proceeds to END 320.

In one embodiment, at END 320 the process for detecting and addressing abnormalities in a financial management system is exited to await new data and/or instructions. As noted above, the specific illustrative examples discussed above are but illustrative examples of implementations of embodiments of the method or process for detecting and addressing abnormalities in a financial management system. Those of skill in the art will readily recognize that other implementations and embodiments are possible. Therefore, the discussion above should not be construed as a limitation on the claims provided below.

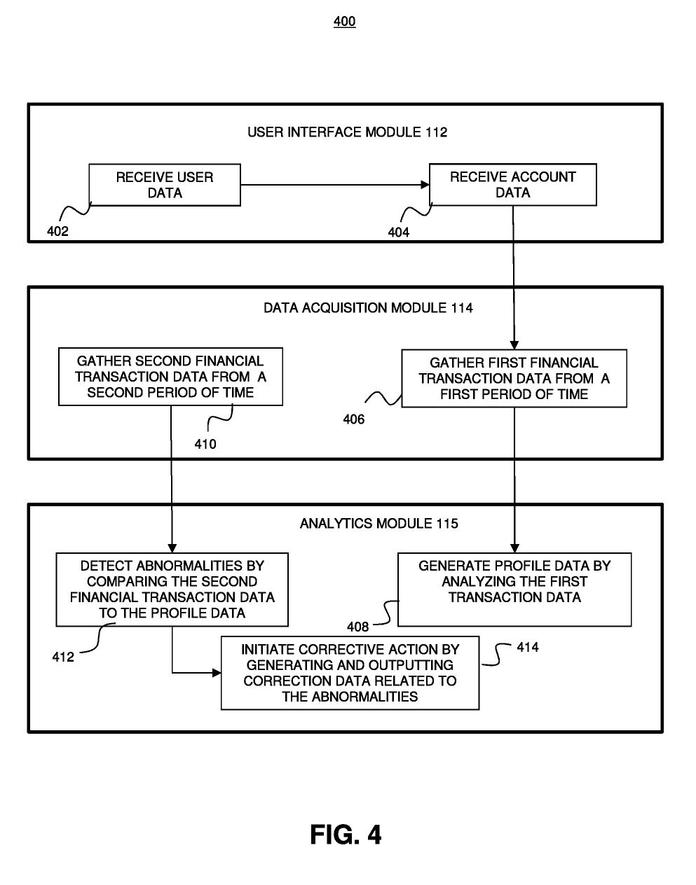

FIG. 4 illustrates a functional flow diagram of a process 400 for detecting and addressing abnormalities in a financial management system, in accordance with one embodiment.

At block 402, the user interface module 112 receives user data related to a plurality of users of a financial management system, according to one embodiment. From block 402 the process proceeds to block 404.

At block 404, the user interface module 112 receives account data related to a plurality of third-party financial accounts of the users, according to one embodiment. From block 404 the process proceeds to block 406.

At block 406, the data acquisition module 114 gathers first financial transaction data related to a plurality of financial transactions of the users from a first period of time, according to one embodiment. From block 406 the process proceeds to block 408.

At block 408, the analytics module 115 generates profile data by analyzing the first financial transaction data, according to one embodiment.

At block 410, the data acquisition module 114 gathers second financial transaction data related to financial transactions of the users from a second period of time, according to one embodiment. From block 410 the process proceeds to block 412.

At block 412, the analytics module 115 detects abnormalities in the second financial transaction data by comparing the second financial transaction data to the profile data, according to one embodiment. From block 412 the process proceeds to block 414.

At block 414 the analytics module 115 initiates corrective action by generating and outputting correction data related to the abnormalities, according to one embodiment.

Although a particular sequence is described herein for the execution of the process 400, other sequences can also be implemented.

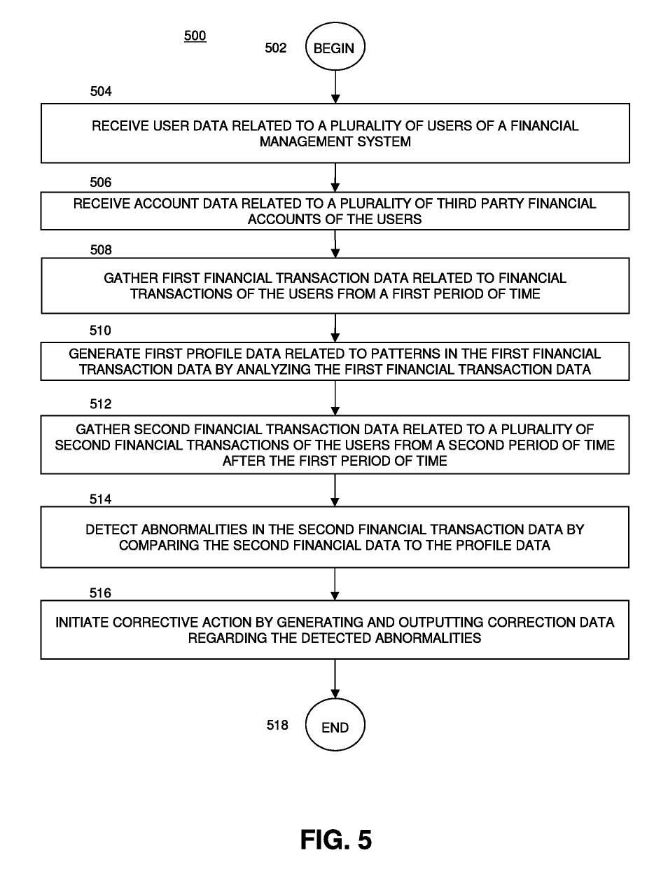

FIG. 5 illustrates a flow diagram of a process 500 for detecting and addressing abnormalities in a financial management system, according to various embodiments.

In one embodiment, process 500 for detecting and addressing abnormalities in a financial management system begins at BEGIN 502 and process flow proceeds to RECEIVE USER DATA RELATED TO A PLURALITY OF USERS OF A FINANCIAL MANAGEMENT SYSTEM 504.

In one embodiment, at RECEIVE USER DATA RELATED TO A PLURALITY OF USERS OF A FINANCIAL MANAGEMENT SYSTEM 504 process 500 for detecting and addressing abnormalities in a financial management system receives user data related to a plurality of users of a financial system.

In one embodiment, once process 500 for detecting and addressing abnormalities in a financial management system receives user data related to a plurality of users of a financial system at RECEIVE USER DATA RELATED TO A PLURALITY OF USERS OF A FINANCIAL MANAGEMENT SYSTEM 504 process flow proceeds to RECEIVE ACCOUNT DATA RELATED TO A PLURALITY OF THIRD PARTY FINANCIAL ACCOUNTS OF THE USERS 506.

In one embodiment, at RECEIVE ACCOUNT DATA RELATED TO A PLURALITY OF THIRD PARTY FINANCIAL ACCOUNTS OF THE USERS 506, process 500 for detecting and addressing abnormalities in a financial management system receives account data related to a plurality of third party financial accounts of the users.

In one embodiment, once process 500 for detecting and addressing abnormalities in a financial management system receives account data related to a plurality of third party financial accounts of the users at RECEIVE ACCOUNT DATA RELATED TO A PLURALITY OF THIRD PARTY FINANCIAL ACCOUNTS OF THE USERS 506, process flow proceeds to GATHER FIRST FINANCIAL TRANSACTION DATA RELATED TO FINANCIAL TRANSACTIONS OF THE USERS FROM A FIRST PERIOD OF TIME 508.

In one embodiment, at GATHER FIRST FINANCIAL TRANSACTION DATA RELATED TO FINANCIAL TRANSACTIONS OF THE USERS FROM A FIRST PERIOD OF TIME 508, process 500 for detecting and addressing abnormalities in a financial management system gathers first financial transaction data related to financial transactions of the users from a first period of time, according to one embodiment.

In one embodiment, once process 500 for detecting and addressing abnormalities in a financial management system gathers first financial transaction data related to financial transactions of the users from a first period of time at GATHER FIRST FINANCIAL TRANSACTION DATA RELATED TO FINANCIAL TRANSACTIONS OF THE USERS FROM A FIRST PERIOD OF TIME 508, process flow proceeds to GENERATE FIRST PROFILE DATA RELATED TO PATTERNS IN THE FIRST FINANCIAL TRANSACTION DATA BY ANALYZING THE FIRST FINANCIAL TRANSACTION DATA 510.

In one embodiment, at GENERATE FIRST PROFILE DATA RELATED TO PATTERNS IN THE FIRST FINANCIAL TRANSACTION DATA BY ANALYZING THE FIRST FINANCIAL TRANSACTION DATA 510 the process 500 generates first profile data related to patterns in the first financial transaction data by analyzing the first financial transaction data.

In one embodiment, once process 500 generates first profile data related to patterns in the first financial transaction data by analyzing the first financial transaction data at GENERATE FIRST PROFILE DATA RELATED TO PATTERNS IN THE FIRST FINANCIAL TRANSACTION DATA BY ANALYZING THE FIRST FINANCIAL TRANSACTION DATA 510, process flow proceeds to GATHER SECOND FINANCIAL TRANSACTION DATA RELATED TO A PLURALITY OF SECOND FINANCIAL TRANSACTIONS OF THE USERS FROM A SECOND PERIOD OF TIME AFTER THE FIRST PERIOD OF TIME 512.

In one embodiment, at GATHER SECOND FINANCIAL TRANSACTION DATA RELATED TO A PLURALITY OF SECOND FINANCIAL TRANSACTIONS OF THE USERS FROM A SECOND PERIOD OF TIME AFTER THE FIRST PERIOD OF TIME 512 the process 500 for detecting and addressing abnormalities in a financial management system gathers second financial transaction data related to a plurality of second financial transactions of the users from a second period of time after the first period of time.

In one embodiment, once the process 500 for detecting and addressing abnormalities in a financial management system gathers second financial transaction data related to a plurality of second financial transactions of the users from a second period of time after the first period of time at GATHER SECOND FINANCIAL TRANSACTION DATA RELATED TO A PLURALITY OF SECOND FINANCIAL TRANSACTIONS OF THE USERS FROM A SECOND PERIOD OF TIME AFTER THE FIRST PERIOD OF TIME 512, process flow proceeds to DETECT ABNORMALITIES IN THE SECOND FINANCIAL TRANSACTION DATA BY COMPARING THE SECOND FINANCIAL DATA TO THE PROFILE DATA 514.

In one embodiment, at DETECT ABNORMALITIES IN THE SECOND FINANCIAL TRANSACTION DATA BY COMPARING THE SECOND FINANCIAL DATA TO THE PROFILE DATA 514 the process 500 for detecting and addressing abnormalities in a financial management system detects abnormalities in the second financial transaction data by comparing the second financial data to the profile data.

In one embodiment, once the process 500 for detecting and addressing abnormalities in a financial management system detects abnormalities in the second financial transaction data by comparing the second financial data to the profile data at DETECT ABNORMALITIES IN THE SECOND FINANCIAL TRANSACTION DATA BY COMPARING THE SECOND FINANCIAL DATA TO THE PROFILE DATA 514, process flow proceeds to INITIATE CORRECTIVE ACTION BY GENERATING AND OUTPUTTING CORRECTION DATA REGARDING THE DETECTED ABNORMALITIES 516.

In one embodiment, at INITIATE CORRECTIVE ACTION BY GENERATING AND OUTPUTTING CORRECTION DATA REGARDING THE DETECTED ABNORMALITIES 516 the process 500 for detecting and addressing abnormalities in a financial management system initiates corrective action by generating and outputting correction data regarding the detected abnormalities.

In one embodiment, once the process 500 for detecting and addressing abnormalities in a financial management system initiates corrective action by generating and outputting correction data regarding the detected abnormalities at INITIATE CORRECTIVE ACTION BY GENERATING AND OUTPUTTING CORRECTION DATA REGARDING THE DETECTED ABNORMALITIES 516, process flow proceeds to END 518.

In one embodiment, at END 518 the process for detecting and addressing abnormalities in a financial management system is exited to await new data and/or instructions. As noted above, the specific illustrative examples discussed above are but illustrative examples of implementations of embodiments of the method or process for detecting and addressing abnormalities in a financial management system. Those of skill in the art will readily recognize that other implementations and embodiments are possible. Therefore, the discussion above should not be construed as a limitation on the claims provided below.

In one embodiment, a computing system implemented method for detecting and addressing abnormalities in a financial management system includes receiving user data related to a plurality of users of a financial management system. The method also includes receiving account data related to a plurality of third party financial accounts of the users, gathering first financial transaction data related to financial transactions of the users from a first period of time, and generating first profile data related to patterns in the first financial transaction data by analyzing the first financial transaction data. The method further includes gathering second financial transaction data related to a plurality of second financial transactions of the users from a second period of time after the first period of time, detecting abnormalities in the second financial transaction data by comparing the second financial data to the profile data, and initiating corrective action by generating and outputting correction data regarding the detected abnormalities.

In one embodiment, a non-transitory computer-readable medium has a plurality of computer-executable instructions which, when executed by a processor, perform a method for detecting and addressing abnormalities in a financial management system. The instructions include a user interface module configured receive user data related to a plurality of users of a financial system and to receive account data related to a plurality of third party financial accounts of the users. The instructions also include an information acquisition module configured to gather first transaction data related to financial transactions of the users from a first period of time and to gather second transaction data related to a plurality of second financial transactions of the users from a second period of time later than the first period of time. The instructions further include an analytics module configured to generate first profile data related to patterns in the first financial transaction data by analyzing the first financial transaction data, to detect abnormalities in the second transaction data by comparing the second financial data to the profile data, and to initiate corrective action by generating and outputting correction data related to the detected abnormalities.

In one embodiment, a system for detecting and addressing abnormalities in a financial management system includes at least one processor and at least one memory coupled to the at least one processor. The at least one memory has stored therein instructions which, when executed by any set of the one or more processors, perform a process. The process includes receiving, with a user interface module of a computing system, user data related to a plurality of users of a financial management system, receiving, with the user interface module, account data related to a plurality of third party financial accounts of the users, and gathering, with a data acquisition module of a computing system, first financial transaction data related to financial transactions of the users from a first period of time. The process further includes generating, with an analytics module of a computing system, first profile data related to patterns in the first financial transaction data by analyzing the first financial transaction data and gathering, with the data acquisition module, second financial transaction data related to a plurality of second financial transactions of the users from a second period of time after the first period of time. The process also includes detecting, with the analytics module of a computing system, abnormalities in the second financial transaction data by comparing the second financial data to the profile data and initiating, with the analytics module, corrective action by generating and outputting correction data regarding the detected abnormalities.

In one embodiment, a computing system implemented method for detecting and addressing abnormalities in a financial management system includes receiving user data related to a plurality of users of a financial management system. The method also includes receiving account data related to a plurality of third party financial accounts of the users, gathering first financial transaction data related to financial transactions of the users from a first period of time, and generating first profile data related to patterns in the first financial transaction data by analyzing the first financial transaction data. The method further includes gathering second financial transaction data related to a plurality of second financial transactions of the users from a second period of time after the first period of time and detecting abnormalities in the second financial transaction data by defining a group of users that have undergone a selected change as reflected by the second financial transaction data and the profile data. The method includes correlating change points in the second financial data for a plurality of user accounts associated with the group, based on the profile data The method also includes determining a cause of the selected change by performing root cause analysis on the second financial transaction data and initiating corrective action by generating and outputting correction data regarding the detected abnormalities.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for detecting and addressing abnormalities in a financial management system, the method comprising:
receiving user data related to a plurality of users of a financial management system;
receiving account data related to a plurality of third party financial accounts of the users;
gathering first financial transaction data related to financial transactions of the users from a first period of time;
generating first profile data related to patterns in the first financial transaction data by analyzing the first financial transaction data;
gathering second financial transaction data related to a plurality of second financial transactions of the users from a second period of time after the first period of time;
detecting abnormalities in the second financial transaction data by comparing the second financial data to the profile data; and
initiating corrective action by generating and outputting correction data regarding the detected abnormalities.

2. The method of claim 1, wherein detecting abnormalities includes defining a group of users that have undergone a selected change as reflected by the second financial transaction data and the profile data.

3. The method of claim 2, wherein defining the group of users includes correlating change points across a plurality of user accounts.

4. The method of claim 3, wherein detecting abnormalities includes determining a cause of the selected change by performing root cause analysis on the second financial transaction data and the profile data related to the group of users.

5. The method of claim 1, wherein detecting abnormalities includes detecting that expected financial transactions are missing from the second transaction data based on the profile data.

6. The method of claim 5, wherein detecting abnormalities includes detecting that a total number of expected financial transactions that are missing falls outside a selected probability threshold.

7. The method of claim 1, wherein outputting the correction data includes setting a flag that an abnormality has been detected.

8. The method of claim 1, wherein outputting correction data includes transmitting data indicating that one or more data collection scripts or processes should be adjusted.

9. The method of claim 1, wherein outputting the correction data includes outputting the correction data to one or more of the users.

10. The method of claim 9, wherein detecting abnormalities includes detecting that one or more users have failed to pay a bill.

11. The method of claim 9 wherein the correction data includes a notification to one or more of the users that an expected financial transaction has not yet occurred.

12. The method of claim 1, wherein one or more of the profiles relates to a frequency of a particular type of financial transaction.

13. The method of claim 1, wherein one or more of the profiles relates to an amount of a particular type of payment.

14. The method of claim 1, wherein the financial transactions include one or more of:
banking transactions;
credit card transactions;
payment of bills;
retirement account activity;
investment activity;
loan activity;
interest accrual;
interest payments;
student loan payments;
mortgage payments;
rent payments; or
tax payments.

15. The method of claim 1, wherein the account data includes account login data for a plurality of third party financial service organizations.

16. The method of claim 1, wherein the account data includes one or more of:
a username;
a password;
a first name;
a last name;
a routing number;
an account number;
an identification number;
a name of a company;
an answer to a security question;
a social security number;
an email address; or
a birthdate.

17. The method of claim 1, wherein the user data includes one or more of:
a first name;
a last name;
a user name;
a password;
a birth date;
a home address; or
a business address.

18. The method of claim 1, further including assigning one or more profiles to one or more of the users based on the profile data and the first financial transaction data related to the one or more users in the first period of time.

19. The method of claim 18, wherein detecting abnormalities includes detecting abnormalities based on the second financial transaction data related to the one or more users not aligning with the profile data based on the one or more profiles to which the one or more users are matched.

20. A non-transitory computer-readable medium having a plurality of computer-executable instructions which, when executed by a processor, perform a method for detecting and addressing abnormalities in a financial management system, the instructions comprising:
a user interface module configured receive user data related to a plurality of users of a financial system and to receive account data related to a plurality of third party financial accounts of the users;
an information acquisition module configured to gather first transaction data related to financial transactions of the users from a first period of time and to gather second transaction data related to a plurality of second financial transactions of the users from a second period of time later than the first period of time; and
an analytics module configured to generate first profile data related to patterns in the first financial transaction data by analyzing the first financial transaction data, to detect abnormalities in the second transaction data by comparing the second financial data to the profile data, and to initiate corrective action by generating and outputting correction data related to the detected abnormalities.

21. The non-transitory computer-readable medium of claim 20 wherein the instructions include a script engine configured to cause the data acquisition module to gather the first and second financial transaction data by executing selected scripts.

22. The non-transitory computer readable medium of claim 20 wherein the analytics module is configured to initiate corrective action by causing the script engine to adjust one or more of the scripts.

23. The non-transitory computer readable medium of claim 20 wherein the user interface module is configured to output the correction data to one or more of the users.

24. The non-transitory computer-readable medium of claim 20 wherein the instructions include a plurality of interchangeable analytics modules each configured to generate the profile data and to detect abnormalities in the second financial transaction data.

25. The non-transitory computer-readable medium of claim 20 wherein the instructions include an analytics module selection engine configured to select the analytics module from the plurality of interchangeable analytics modules.

26. The non-transitory computer-readable medium of claim 20 wherein the analytics module is configured to define a group of users that have undergone a selected change as reflected by the second financial transaction data and the profile data.

27. The non-transitory computer-readable medium of claim 26 wherein the analytics module is configured to define the group of users by correlating change points across a plurality of user accounts.

28. The non-transitory computer-readable medium of claim 27 wherein the analytics module is configured to determine a cause of the selected change by performing root cause analysis on the second financial transaction data and the profile data related to the group of users.

29. A system for detecting and addressing abnormalities in a financial management system, the system comprising:
at least one processor; and
at least one memory coupled to the at least one processor, the at least one memory having stored therein instructions which, when executed by any set of the one or more processors, perform a process including:
receiving, with a user interface module of a computing system, user data related to a plurality of users of a financial management system;
receiving, with the user interface module, account data related to a plurality of third party financial accounts of the users;
gathering, with a data acquisition module of a computing system, first financial transaction data related to financial transactions of the users from a first period of time;
generating, with an analytics module of a computing system, first profile data related to patterns in the first financial transaction data by analyzing the first financial transaction data;
gathering, with the data acquisition module, second financial transaction data related to a plurality of second financial transactions of the users from a second period of time after the first period of time;
detecting, with the analytics module of a computing system, abnormalities in the second financial transaction data by comparing the second financial data to the profile data; and
initiating, with the analytics module, corrective action by generating and outputting correction data regarding the detected abnormalities.

30. The system of claim 29, wherein detecting abnormalities includes defining a group of users that have undergone a selected change as reflected by the second financial transaction data and the profile data.

31. The system of claim 30, wherein defining the group of users includes correlating change points across a plurality of user accounts.

32. The system of claim 30, wherein detecting abnormalities includes determining a cause of the selected change by performing root cause analysis on the second financial transaction data and the profile data related to the group of users.

33. The system of claim 29, wherein detecting abnormalities includes detecting that expected financial transactions are missing from the second transaction data based on the profile data.

34. The system of claim 33, wherein detecting abnormalities includes detecting that a total number of expected financial transactions that are missing falls outside a selected probability threshold.

35. The system of claim 29, wherein outputting the correction data includes setting a flag that an abnormality has been detected.

36. The system of claim 29, wherein outputting correction data includes providing, to a script engine of a computing system, the correction data indicating that one or more data collection scripts or processes should be adjusted.

37. The system of claim 29, wherein outputting the correction data includes outputting, with the user interface module, the correction data to one or more of the users.

38. The system of claim 37, wherein detecting abnormalities includes detecting that one or more users have failed to pay a bill.

39. The system of claim 29 wherein the correction data includes a notification to one or more of the users that an expected financial transaction has not yet occurred.

40. The system of claim 29, wherein one or more of the profiles relates to a frequency of a particular type of financial transaction.

41. The system of claim 29, wherein one or more of the profiles relates to an amount of a particular type of payment.

42. The system of claim 29, wherein the financial transactions include one or more of:
banking transactions;
credit card transactions;
payment of bills;
retirement account activity;
investment activity;
loan activity;
interest accrual;
interest payments;
student loan payments;
mortgage payments;
rent payments; or
tax payments.

43. The system of claim 29, wherein the account data includes account login data for a plurality of third party financial service organizations.

44. The system of claim 29, wherein the account data includes one or more of:
a username;
a password;
a first name;
a last name;
a routing number;
an account number;
an identification number;
a name of a company;
an answer to a security question;
a social security number;
an email address; or
a birthdate.

45. The system of claim 29, wherein the user data includes one or more of:
a first name;
a last name;
a user name;
a password;
a birth date;
a home address; or
a business address.

46. The system of claim 29, further including assigning one or more profiles to one or more of the users based on the profile data and the first financial transaction data related to the one or more users in the first period of time.

47. The system of claim 46, wherein detecting abnormalities includes detecting abnormalities based on the second financial transaction data related to the one or more users not aligning with the profile data based on the one or more profiles to which the one or more users are matched.

48. The system of claim 47, wherein gathering the first financial transaction data includes gaining access to the first financial transaction data by providing the account data from the data acquisition module to one or more third party financial organizations.
